(19) United States
(12) Patent Application Publication
(10) Pub. No.: US 2009/0244001 A1
(43) Pub. Date: Oct. 1, 2009

(54) BACK PLATE, DISPLAY, DISPLAY SYSTEM, METHOD OF SUPPLYING AN ELECTRIC POWER, AND DISPLAY METHOD

(75) Inventors: Yutaka NAKAI, Yokohama-shi (JP); Tsuyoshi HIOKI, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/403,040

(22) Filed: Mar. 12, 2009

(30) Foreign Application Priority Data
Mar. 28, 2008 (JP) 2008-087987

(51) Int. Cl. G09G 5/00

(52) U.S. Cl. 345/156; 345/211

(57) ABSTRACT

According to one embodiment, a back plate includes: a base plate including a principal surface on which a plurality of power supplying portions, a plurality of image signal transmitting portions, and a position detecting portion are disposed, each of the position detecting portions being configured to detect a position of a display device having a position marker; and a controller including: a detector configured to detect position information and attitude information of the display device, a selector configured to select at least one of power supplying portions and at least one of image signal transmitting portions, a power supply controller configured to supply an electric power to the selected power supplying portion, an image signal generator configured to produce image signal, and an image signal supply controller configured to supply the produced image signal to the selected image signal transmitting portion.

### CROSS-REFERENCE TO RELATED APPLICATIONS

This application is based upon and claims the benefit of priority from Japanese Patent Application No. 2008-087987, filed Mar. 28, 2008, the entire contents of which are incorporated herein by reference.

### BACKGROUND

1. Field

The present invention relates to a back plate for a display in which a video is displayed in a multi-display system, a display, a display system, a method of supplying an electric power, and a display method.

2. Description of the Related Art

Recently, viewing an image larger than an image displayed by a conventional display apparatus has been requested. Also a request for viewing an image at a layout and size which are suited to the taste of the user is enhanced. As a result, occasions to display an image on a plurality of displays, and to change positions of displays are gradually increased.

In a method for displaying an image on a plurality of displays as described above, a larger image is displayed by closely arranging the displays without forming a gap therebetween. This is called tiled display. By contrast, different information or images may be displayed on the displays, and the displays may be freely laid out, thereby organizing the information and the images.

In such a multi-display system, usually, power source cables are used for supplying an electric power to the displays. Also, cables are usually used for transmitting a video signal to the displays.

In the case where an image display is performed by using displays, when video signal and power transmission cables are employed, however, it is difficult to change the layout while freely moving the displays. In a multi-display system using a plurality of displays, moreover, many video signal and power transmission cables are connected to the displays, and hence also the difficulty in preventing the cables from spoiling the beauty occurs.

Therefore, it is contemplated that transmissions of a video signal and an electric power are realized by wireless systems. In JP-A 2005-173291(KOKAI), a video signal can be transmitted to plural displays by using a wireless system.

JP-A 2007-47512(KOKAI) discloses a method in which an electric power is supplied from an antenna to a plurality of display systems by means of electromagnetic induction, whereby a wireless power transmission is enabled.

However, there are the following disadvantages in realizing a multi-display system.

A high definition image which is typified by Hi-Vision is widely used, so that a high speed is requested also in a transmission of a video signal. As a result, a high-speed communication method in the gigahertz band tends to be used. As the communication distance is longer, however, the rate of occurrence of communication errors is higher. Moreover, the error occurrence rate is further increased because of interference with surrounding radio waves. Namely, it is required to shorten the communication distance as far as possible.

This is similarly applicable also to the power supply. A system based on electromagnetic induction is often used in a wireless power supply. As described in an electromagnetics textbook, electromagnetic induction attenuates by the reciprocal of the power of the distance between supplying means and receiving means. When the power supply distance is not shortened, therefore, the power supply efficiency is lowered. In the case where an electric power is supplied from one supplying means to plural receiving means, even when the distance between the one supplying means and one of the receiving means is made shortest, it is not easy to properly manage the distances with respect to the other receiving means.

### SUMMARY OF THE INVENTION

According to an aspect of the present invention, there is provided a back plate including: a base plate including a principal surface on which a plurality of power supplying portions, a plurality of image signal transmitting portions, and a position detecting portion are disposed, each of the position detecting portions being configured to detect a position of a display device having a position marker that output information to inform the position of the display device; and a controller including: a detector configured to detect position information and attitude information of the display device based on information output from the position detecting portion, a selector configured to select at least one of power supplying portions and at least one of image signal transmitting portions for operating the display device based on the position information and the attitude information, a power supply controller configured to supply an electric power to the selected power supplying portion, an image signal generator configured to produce image signal corresponding to the display device, and an image signal supply controller configured to supply the produced image signal to the selected image signal transmitting portion.

According to another aspect of the present invention, there is provided a display device configured to be placed on a back plate to display an image including: a position marker configured to output information to allow the back plate to detect a position of the display device; a power receiving portion configured to receive an electric power supplied from the back plate; and an image signal receiving portion configured to receive an image signal transmitted from the back plate, a display portion configured to display the received image.

According to another aspect of the present invention, there is provided a display system including: a back plate having: a base plate including a principal surface on which a plurality of power supplying portions, a plurality of image signal transmitting portions, and a position detecting portion are disposed, each of the position detecting portions being configured to detect a position of a display device having a position marker that output information to inform the position of the display device; and a controller including: a detector configured to detect position information and attitude information of the display device based on information output from the position detecting portion, a selector configured to select at least one of power supplying portions and at least one of image signal transmitting portions for operating the display device based on the position information and the attitude information, a power supply controller configured to supply an electric power to the selected power supplying portion, an image signal generator configured to produce image signal corresponding to the display device, and an image signal supply controller configured to supply the produced image signal to the selected image signal transmitting portion; and a display device configured to be placed on the back plate to display the produced image including: a position marker configured to output information to allow the back plate to detect the position of the display device; a power receiving portion configured to receive the electric power supplied from the back plate; and an image signal receiving portion configured to receive the produced image signal transmitted from the back plate, a display portion configured to display the received image.

According to another aspect of the present invention, there is provided a power-supply method for supplying an electric power for a display device having a position marker and a power receiving portion, the display device being configured to be disposed on a base plate having a position detecting portion and a plurality of power supplying portions, the method including: detecting position information and attitude information of a display device based on information that the position detecting portion obtains from the position marker; selecting at least one of the power supplying portions based on the position information and attitude information; and supplying an electric power to the selected power supplying portion to supply the electric power to the power receiving portion.

According to another aspect of the present invention, there is provided an image display method for displaying an image on a display device having a position marker and an image signal receiving portion, the display being configured to be disposed on a base plate having a position detecting portion and a plurality of image signal transmitting portions, the method including: detecting position information and attitude information of a display device based on information that the position detecting portion obtains from the position marker; selecting at least one of image signal transmitting portions based on the position information and attitude information; and producing an image signal to be displayed on the display device based on the position information and attitude information; and supplying the produced image signal to the selected image signal transmitting portion to supply the produced image signal to the image signal receiving portion.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary configuration diagram showing the back plate of the invention.

FIG. 2 is an exemplary configuration diagram of a control portion in the invention.

FIG. 3 is an exemplary configuration diagram of a base board in the invention.

FIGS. 4A and 4B are exemplary sectional views of the base board in the invention.

FIG. 5 is an exemplary configuration diagram of the display of the invention.

FIG. 6 is an exemplary sectional view of the display of the invention.

FIG. 7 is an exemplary configuration diagram of the display system of the invention.

FIGS. 8A and 8B are exemplary sectional views of the display system of the invention.

FIG. 9 shows an exemplary display example in the display system of the invention.

FIG. 10 shows an exemplary modification of the display example in the display system of the invention.

FIG. 11 is an exemplary process flowchart showing the method of supplying an electric power of the invention.

FIG. 12 shows an exemplary display example indicating an embodiment of the display system of the invention.

FIG. 13 shows an exemplary display example indicating another embodiment of the display system of the invention.

FIG. 14 shows an exemplary display example indicating a further embodiment of the display system of the invention.

FIG. 15 is an exemplary process flowchart showing the display method of the invention.

FIG. 16 is an exemplary diagram showing a state where the display of the invention has not yet been contacted with a base plate 5.

FIG. 17 is an exemplary diagram showing a state where the display of the invention is contacted with the base plate.

### DETAILED DESCRIPTION

A back plate, display, display system, method of supplying an electric power, and display method of an embodiment of the invention will be described.

### [Back Plate]

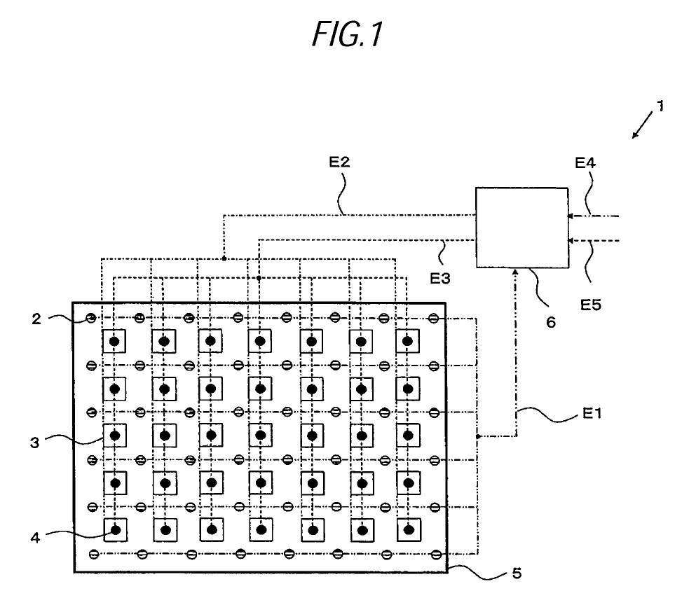

FIG. 1 is a configuration diagram showing the back plate of the invention.

The back plate 1 which is used in the invention has position detecting means 2, power supplying means 3, video signal transmitting means 4, a base plate 5, and a control portion 6.

In accordance with the use of the back plate, the position detecting means 2, the power supplying means 3, and the video signal transmitting means 4 are placed at an arbitrary number on the base plate 5. The placement where the means are used in a plural number is more preferable because the accuracies of position and attitude detections are improved, a power supply loss in a power supply is reduced, and errors are less caused in transmission and reception of a video signal. As in the matrix-like form shown in FIG. 1, the means may be placed at geometrically symmetrical positions.

A printed circuit board may be used as the base plate 5, and the position detecting means 2, the power supplying means 3, and the video signal transmitting means 4 may be formed on the board. Alternatively, a fabric substrate may be used as the base plate 5, and the position detecting means 2, the power supplying means 3, and the video signal transmitting means 4 may be formed by sewing the means into the fabric substrate. In this way, the base plate 5 has a certain shape including a two-dimensional surface regardless of whether the shape is planar or curved. Specifically, the base plate 5 having a planar, cylindrical, semicylindrical shape, or the like is exemplified.

As the position detecting means 2, any means may be used as far as it produces an effect in a non-contact manner between a position marker 101 which will be described later, and the position detecting means 2. For example, a plurality of position detecting means 2 may sense the intensity of a weak electromagnetic wave transmitted from the position marker 101. When such means are used, the coordinates of the position marker 101 can be accurately detected.

AS the power supplying means 3, a power supply antenna for supplying by wireless an electric power to power receiving means 102 which is placed in a display 100 that will be described later may be used.

In the video signal transmitting means 4, an antenna for supplying by wireless a video signal to video signal receiving means 103 which is placed in the display 100 may be used (for example, an antenna for receiving a video signal). When this means is used, a video signal is supplied by wireless from video signal transmitting means 4 to the video signal receiving means 103 of the display 100. The video signal transmitting means 4 is selected from video signal transmitting means which are placed at a plural number on the base plate 5 of the back plate 1, and selected in accordance with a display method that will be described later.

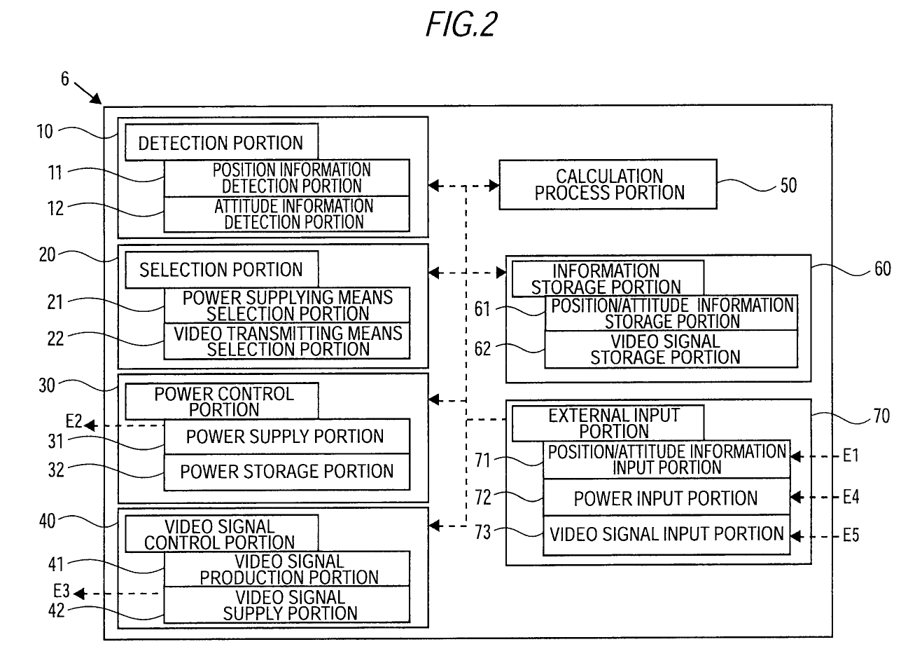

FIG. 2 shows the control portion 6. The control portion 6 has a detection portion 10, a selection portion 20, a power control portion 30, a video signal control portion 40, a calculation process portion 50, an information storage portion 60, and an external input portion 70. These portions are electrically connected to each other, so that information and an electric power can be exchanged.

The detection portion 10 has a position information detection portion 11 and an attitude information detection portion 12. On the basis of information (position information and attitude information) which is sent from the position detecting means 2 through a signal line E1, the position information detection portion 11 and the attitude information detection portion 12 perform a calculation process in the calculation process portion 50 which will be described later, to obtain the coordinates of the position marker 101 (101a, 101b, 101c) disposed in the display 100 shown in, for example, FIG. 13. This enables the position and attitude information of the display 100 to be detected. Here, the position information means information related to the translation direction of the display 100 with respect to the base plate 5, and the attitude information means information related to the angle (inclination) of the display 100 with respect to the base plate 5.

The selection portion 20 selects the power supplying means 3 and video signal transmitting means 4 which correspond to the display 100, on the basis of the position and attitude information of the display 100 which is obtained in the detection portion 10.

The power control portion 30 has a power supply portion 31, and, in addition, may have a power storage portion 32. The power supply portion 31 supplies an electric power to the power receiving means 102 of the display 100 which is selected by the selection portion 20, through a power supply line E2 and the power supplying means 3. The electric power is introduced from the external into a power input portion 72 of the control portion 6. Part of the electric power which is externally introduced may be stored into the power storage portion 32. In the case where a power source does not exist in the vicinity of the display, part or whole of the power stored in the power input portion 72 may be supplied to the power receiving means 102.

The video signal control portion 40 has a video signal production portion 41 and a video signal supply portion 42. The video signal production portion 41 produces a video signal corresponding to the display 100 which is selected by the selection portion 20 on the basis of the position and attitude information of the display 100. The video signal supply portion 42 supplies the video signal produced by the video signal production portion 41 to the video signal receiving means 103 selected by the selection portion 20, through a video signal supply line E3 and the video signal transmitting means 4.

The external input portion 70 has a position/attitude information input portion 71, a power input portion 72, and a video signal input portion 73. The position/attitude information input portion 71 is connected to the position detecting means 2 through the signal line E1. The power input portion 72 is connected to an external power source (not shown) through power wiring E4. As the external power source, for example, an AC power source for household appliance may be used. The video signal input portion 73 is connected to an external video signal source (not shown) through a video signal line E5.

The calculation process portion 50 is connected to the detection portion 10, the selection portion 20, the power control portion 30, the video signal control portion 40, the information storage portion 60, and the external input portion 70, and performs calculation processes of the position information, the attitude information, and the video signal. Specifically, the following calculation processes are performed. The calculation process portion performs calculation processes of detecting the position and attitude information of the display 100 on the basis of information which is sent from the position detecting means 2 through the signal line E1. Results of the calculation processes of the position and attitude information are sent to the position information detection portion and the attitude information detection portion. In addition, also a process of sending these sets of information to a position/attitude information storage portion 61 which will be described later may be performed. Furthermore, the calculation process portion 50 performs calculation processes of selecting the power supplying means 3 and video signal transmitting means 4 which correspond to the display 100, on the basis of the position and attitude information of the display 100 which is obtained from the detection portion 10. The calculation process portion 50 performs a calculation process of producing a video signal corresponding to the display 100 selected by the selection portion 20, and sends the video signal after the calculation process to the video signal supply portion 42.

The information storage portion 60 has the position/attitude information storage portion 61 and a video signal storage portion 62. The position/attitude information storage portion 61 stores current or past position and attitude information. The video signal storage portion 62 may store a video signal which is input in current or past times, and that which is produced in current or past times. The position/attitude information storage portion may further store information (the size, the power consumption, and the video specification) related to the display 100, and that (the size, the power consumption, and the specifications of the position detecting means 2, the power supplying means 3, and the video signal transmitting means 4 related to the back plate 1. The information may be used in the above-described calculation processes.

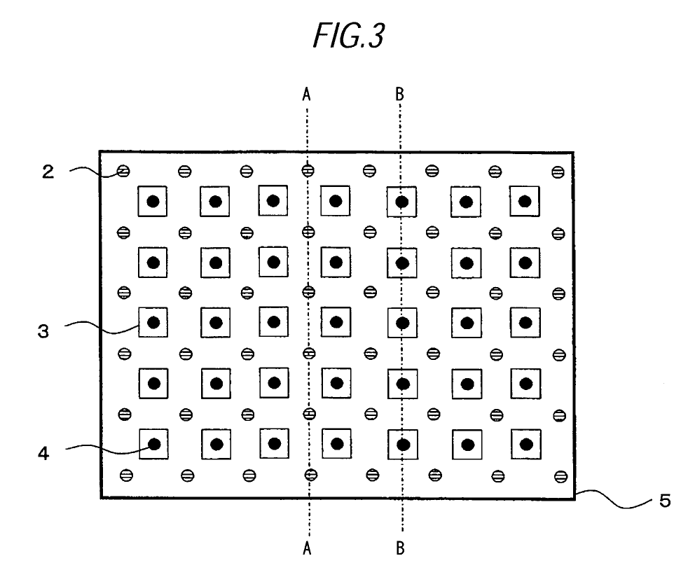

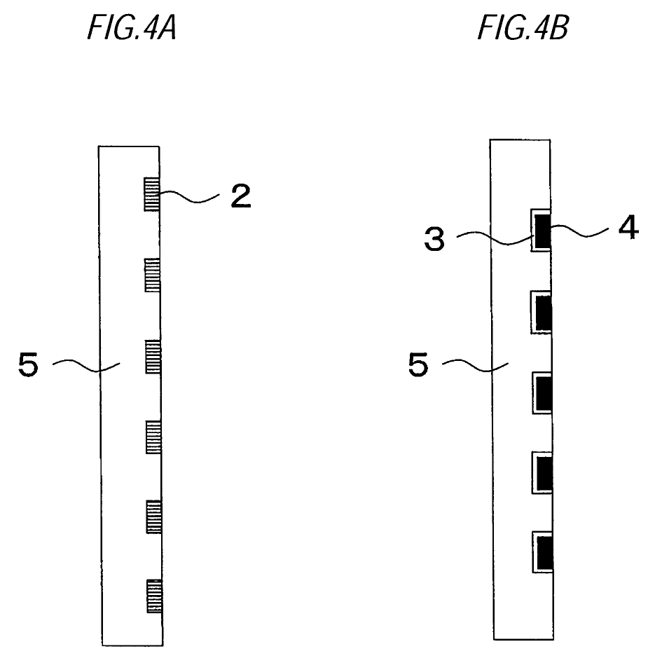

FIG. 3 is a view in which the base plate 5 of the back plate 1 is particularly extracted. A sectional view taken along A-A in FIG. 3 is shown in FIG. 4A, and a sectional view taken along B-B is shown in FIG. 4B. As shown in FIGS. 4A and 4B, the position detecting means 2, the power supplying means 3, and the video signal transmitting means 4 are preferably placed on the surface (principal surface) of the base plate 5 on which a display is to be placed, because of, for example, the following reasons. When the display 100 is placed on the base plate 5, the distance between them is shortened as far as possible, and, as the distance is shorter, detections of the position and attitude of the display 100 are more accurate. The power supply loss in the power supply is reduced. Errors are less caused in transmission and reception of a video signal.

### [Display]

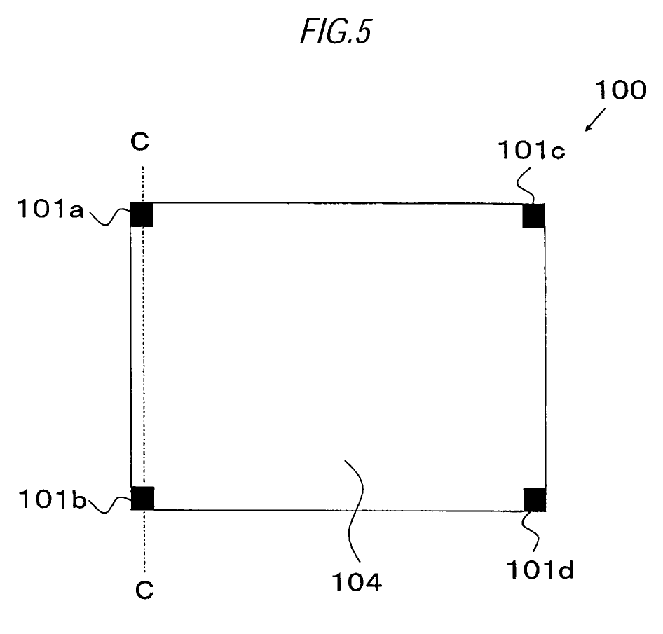

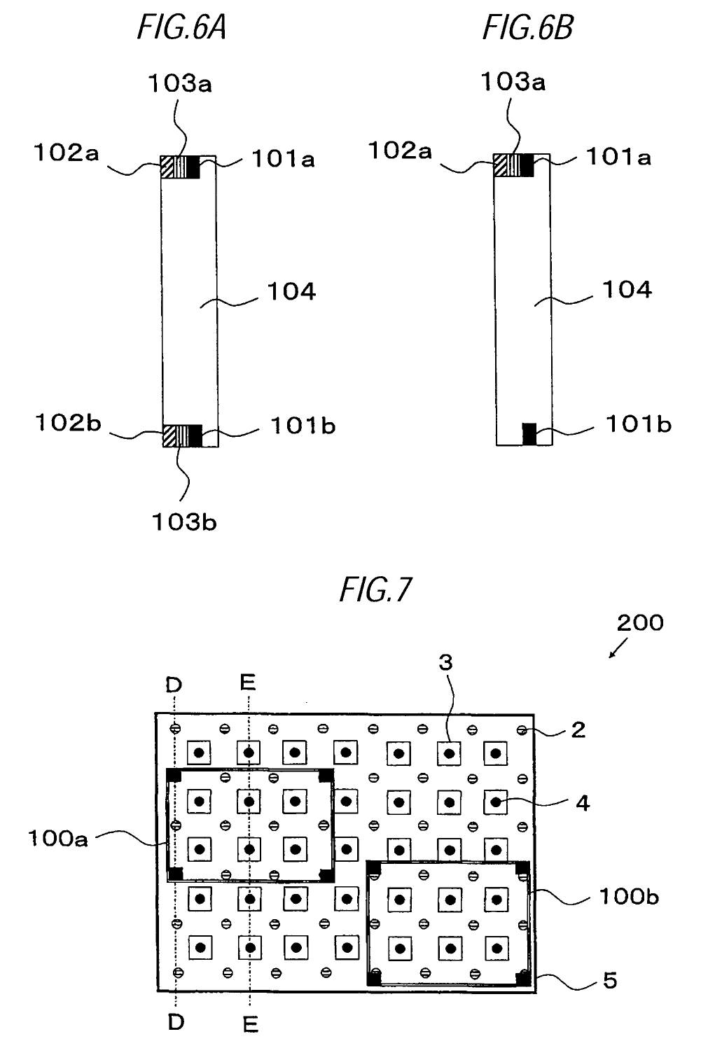

FIG. 5 is a configuration diagram showing the display of the invention. FIG. 6A shows a sectional view taken along C-C in the display 100 shown in FIG. 5.

The display 100 which is used in the invention has the position marker 101 (101a, 101b, 101c, 101d), power receiving means 102 (102a, 102b, 102c, 102d, but the means 102c, 102d are not shown), video signal receiving means 103 (103a, 103b, 103c, 103d, but the means 103c, 103d are not shown), and a display portion 104.

The position marker 101 provides the position detecting means 2 with the own position of the display 100, i.e., information of the position and attitude at which the display 100 is placed. Specifically, as described above, a marker which produces an effect in a non-contact manner with respect to the position detecting means 2 may be used. For example, a transmitter which emits a weak electromagnetic wave may be used as the position marker 101, and receivers which receive the electromagnetic wave as the position detecting means. According to the configuration, the plurality of position detecting means 2 which are placed on the base plate 5 receive the intensity of the weak electromagnetic wave from the position marker 101 of the display 100, as a signal, and send the information to the position/attitude information input portion 71 of the control portion 6 through the signal line 6. The calculation process portion 50 applies a calculation process on the information, and sends a result of the process to the detection portion 10. The intensity of an electromagnetic wave is obtained as a function of the distance. When the intensity of the weak electromagnetic wave is obtained by the plural position detecting means 2, therefore, the position of the position marker 101 is uniquely determined. In the case where the display has a plurality of position markers 101, the signals from the position markers may be sequentially serially transmitted, so that their positions may be obtained. When electromagnetic waves having different frequencies are used, it is possible to individually identify the position markers.

As a result of these processes, the position of the display 100 is detected. Namely, the coordinates of the position marker 101 (101a, 101b, 101c) are obtained, and, from the coordinates, the position and attitude information of the display 100 can be accurately obtained. In order to obtain coordinates from a signal which is a weak electromagnetic wave sent from the position marker 101, for example, a database which is previously prepared may be stored in the information storage portion, and the position and attitude information may be obtained with reference to the database. Alternatively, a calculation process may be performed in each case by using a geometrical formula, thereby obtaining the position and attitude information.

When the position marker 101 is placed at each apex of the display 100 as shown in FIG. 5, the coordinates of the apexes of the display 100, other information such as the inclination, size, and curvature of the display may be obtained.

In the case where the display is rigid and rectangular, for example, when at least three planar position markers 101 exist, it is possible to identify the position and attitude of the display 100. By contrast, in the case where the display 100 is elastic and hence a curved surface is formed, the display preferably has a plurality of position markers in order to obtain the curvature of the curved surface. The number of the position markers 102 is appropriately selected in accordance with the rigidity, size, and shape of the display 100. Alternatively, an information storage portion (not shown) which stores information related to the specification of the display 100 may be disposed in the position markers 101, and the control portion 6 may adequately obtain and refer the information. In the case where a plurality of displays 100 is disposed, information (display identification information) which identifies the displays may be stored so that each of the displays 100 can be identified.

The power receiving means 102 has a function of receiving the electric power supplied from the power supplying means 3. The electric power is used as a power source for displaying a video signal on the display 100, and also as that for transmitting a weak electromagnetic wave from the position marker 101. Means having an antenna for supplying and receiving an electric power by wireless may be used as the power supplying means 3 and the power receiving means 102. A power storage portion (not shown) may be disposed in the power receiving means 102 so as to store a minimum electric power which is initially required for transmitting a weak electromagnetic wave. According to the configuration, the position marker 101 can transmit an electromagnetic wave before the marker receives the electric power from the power supplying means 3.

The video signal receiving means 103 has a function of receiving the video signal supplied from the video signal transmitting means 4. The video signal is previously produced in the video signal production portion 41, and then supplied from the video signal supply portion 42 to the video signal transmitting means 4 through the video signal supply line E3, and further to the video signal receiving means 103. Means having an antenna for transmitting and receiving a video signal by wireless may be used as the video signal transmitting means 4 and the video signal receiving means 103.

FIG. 6A shows the configuration where the pluralities of power receiving means 102 (102a, 102b) and video signal receiving means 103 (103a, 103b) are overlappingly disposed in the display 100 (100a, 100b). As shown in FIG. 6B, alternatively, one display 100 may have one power receiving means 102 and one video signal receiving means 103 in accordance with the specification of the display such as the size and the power consumption.

The display portion 104 has a function of displaying the video signal received by the video signal receiving means 103. A specific operation of the display portion 104 will be exemplarily described below. A power switch (not shown) disposed in the display portion 104 is turned on to cause the position marker 101 to transmit a weak electromagnetic wave, and the power receiving means to be set to a waiting state. After the display portion 104 is contacted with the base plate 5, the power receiving means receives an electric power sent from the power supplying means which most closely approaches the power receiving means. With using the electric power, furthermore, the video signal receiving means and a video signal processing circuit (not shown) are activated. The video signal receiving means receives a video signal transmitted from the video signal transmitting means which most closely approaches the video signal receiving means, and the video signal processing circuit processes the video signal and then sends data to the display to display an image. The power switch disposed in the display portion 104 is turned off to quit the transmission of the weak electromagnetic wave from the position marker 101 and stop the power receiving means, the video signal receiving means, and the video signal processing circuit.

The connection and interruption of the above-mentioned power switch may be controlled by using means which is disposed in the display portion 104, and which detects contact between the display portion and the base plate 5. In this case, when the display portion is contacted with the base plate 5, a pressure sensor senses the contact, and the power switch of the display portion is turned on. When the display portion is removed from the base plate, the power switch is turned off by a signal from the pressure sensor.

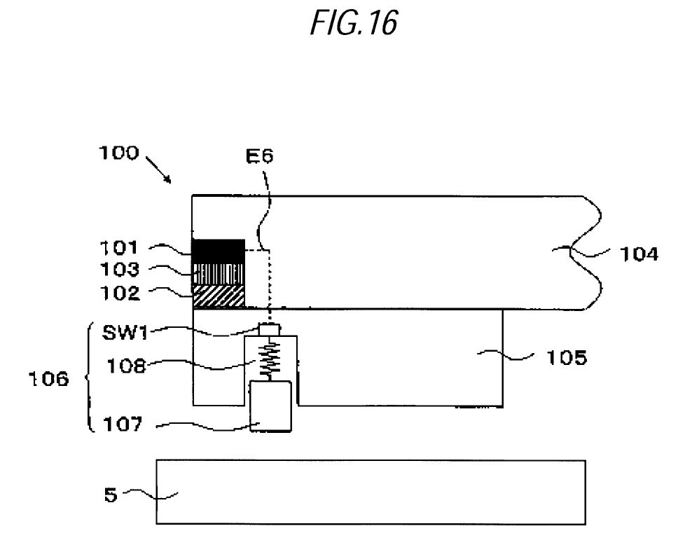

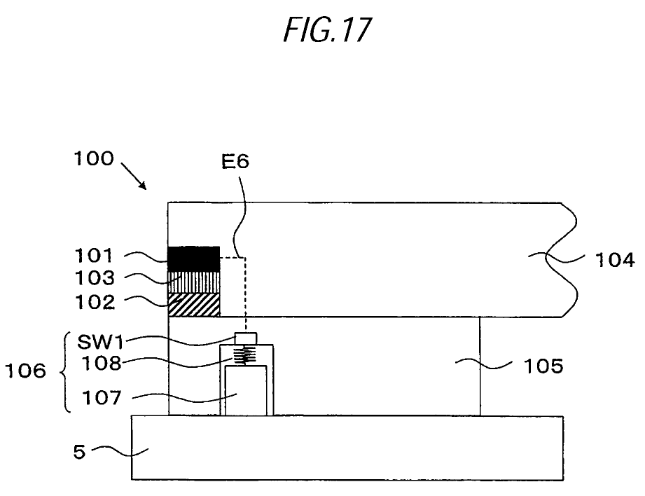

The configuration and operation of a specific example of the pressure sensor will be specifically described with reference to FIGS. 16 and 17. FIG. 16 is a diagram showing a state where the display 100 has not yet been contacted with the base plate 5, and FIG. 17 is a diagram showing a state where the display 100 is correctly contacted with the base plate 5.

FIGS. 16 and 17 show a case where a fixation portion 105 has a pressure sensor 106. The pressure sensor 106 has a press button 107, urging means 108, and a switch SW1. The press button 107 is connected with the switch SW1 through the urging means 108. The urging means 108 has a function of, when the press button 107 is depressed, transmitting the depression to the switch SW1. A metal spring or the like may be used as the urging means 108. The switch SW1 is connected with the position marker 101 through a contact state detection signal line E6. The switch SW1 has a function of, when a predetermined pressure is detected, informing the position marker 101 of the depression. As a method of realizing this, for example, the switch SW1 is configured so that, when the switch is depressed by a pressure which is higher than a predetermined value, the circuit of the contact state detection signal line E6 is short-circuited.

In the pre-contact state shown in FIG. 16, the press button 107 and the urging means 108 are released, and the switch SW1 is in an opened state. By contrast, as shown in FIG. 17, when the display 100 is contacted with the base plate while using the above-described electromagnetic force as fixing means, the press button 107 is depressed by the base plate 5 to compress the urging means 108. Then, the urging means 108 depresses the switch SW1 to short-circuit the circuit of the contact state detection signal line E6. The contact state detection signal line E6 senses the short-circuited state, and informs the position marker 101 of the contact of the base plate 5. After receiving the information, the position marker 101 may perform a display position/attitude information detecting step S1.

In the case where the base plate 5 has a plurality of fixation portions 105, the pressure sensor 106 may be disposed in each of the fixation portions 105. For example, a case where the fixation portions 105 are placed respectively in the four corners of the base plate 5 having a rectangular shape, and pressure sensors 106 are disposed respectively in the fixation portions corresponds to this configuration. According to the configuration, it is possible to detect with higher reliability whether the display 100 is adequately contacted with the base plate 5 or not. In this case, when the switches SW1 are connected in series, it is possible to detect that all the pressure sensors 106 are adequately contacted with the base plate.

In order to perform these operations, the display 100 may have a display power supply portion (not shown). A button cell or a rechargeable secondary cell may be used as the display power supply portion. The position marker 101 and the like can receive the power supply from the display power supply portion, and transmit a weak electromagnetic wave.

A series of processes related to the operation of the display 100 are controlled by a display control portion (not shown) disposed in the display 100.

For example, a liquid crystal display or an organic EL display may be used as the display portion 104.

In the case where the face of the display portion 104 on which a video is displayed and the user views the video is assumed as “surface”, the position marker 101, the power receiving means 102, and the video signal receiving means 103 are preferably placed on the rear face opposite to the surface, for reasons such as that, when the display 100 is placed on the base plate 5, the accuracies of detections of the position and attitude of the display 100 are more improved as these components (the position marker 101, the power receiving means 102, and the video signal receiving means 103) are closer as far as possible to the position detecting means 2, the power supplying means 3, and the video signal transmitting means 4, the power supply loss in the power supply can be reduced, errors are less caused in transmission and reception of a video signal, and the size of the display portion 104 can be increased as far as possible.

### [Display System]

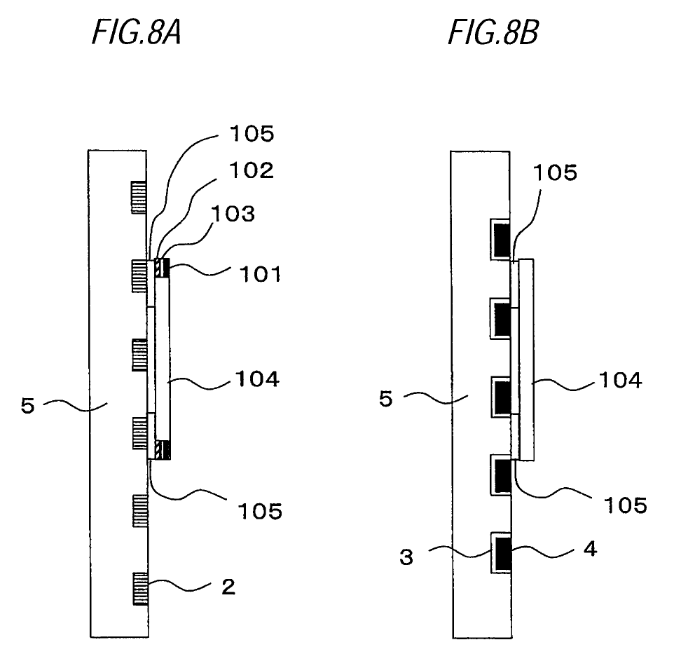

FIG. 7 is a configuration diagram showing a display system 200, FIG. 8A diagrammatically shows a section of the display system 200 taken along D-D, and FIG. 8B diagrammatically shows a section of the display system taken along E-E.

The display system 200 of the invention has the back plate 1 and display 100 which have been described above.

A plurality of displays 100 (100a, 100b) can be placed at arbitrary positions on the base plate 5. In the case where an electrostatic force or an electromagnetic force is used as fixing means in the placement, even after the displays are attached to the back plate, the displays can be detached by an adequate force and then attached to other positions.

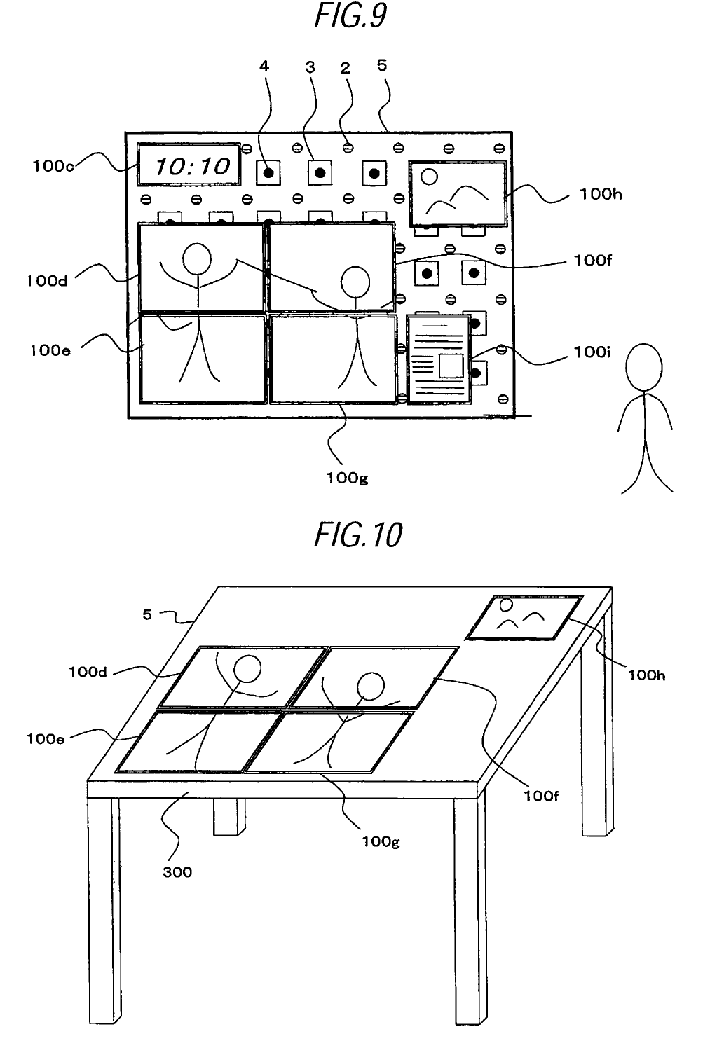

As shown in FIG. 9, the base plate 5 may have a shape of a square of several meters, and may be applied to a wall of a house. Alternatively, the back plate may be embedded in the wall. In FIG. 9, for the sake of technical understanding and convenience, the position detecting means 2, the power supplying means 3, and the video signal transmitting means 4 remain to be illustrated. However, the actual surface may have a woodgrain, black, or fibrous finish.

As shown in FIG. 10, the upper face of furniture such as a desk or a fixture 300 may be configured as the back plate 1. In this case, the displays 100 are placed while being upward directed as in FIG. 10.

### [Method of Supplying Electric Power]

A method of supplying an electric power to the display in the display system will be described.

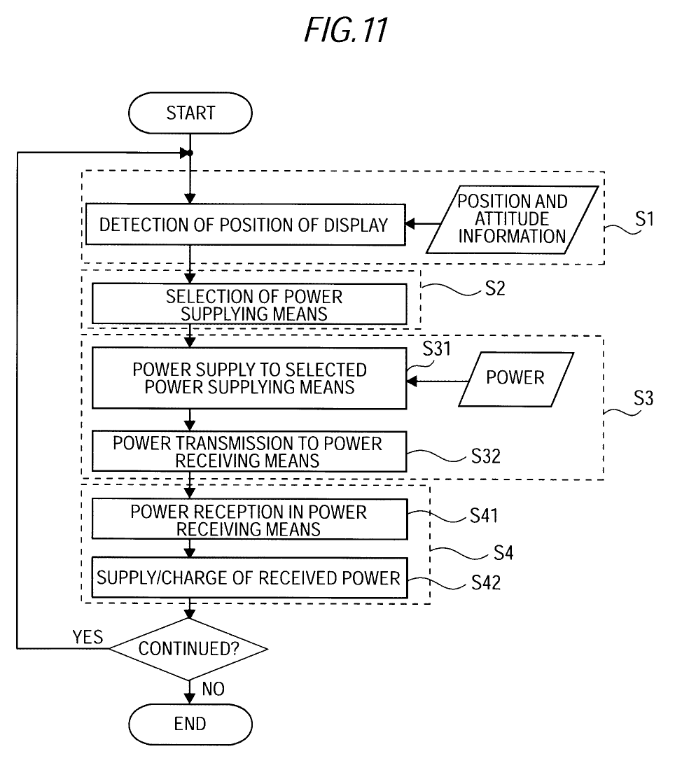

FIG. 11 is a flowchart of a process showing an embodiment of the method of supplying an electric power, and display method of the invention. The method of supplying an electric power may have the display position/attitude information detecting step S1, a power supplying means selecting step S2, and a power supplying/transmitting step S3. The method may have further a power receiving/supplying step S4 after the power supplying/transmitting step S3.

### (Display Position/Attitude Information Detecting Step: S1)

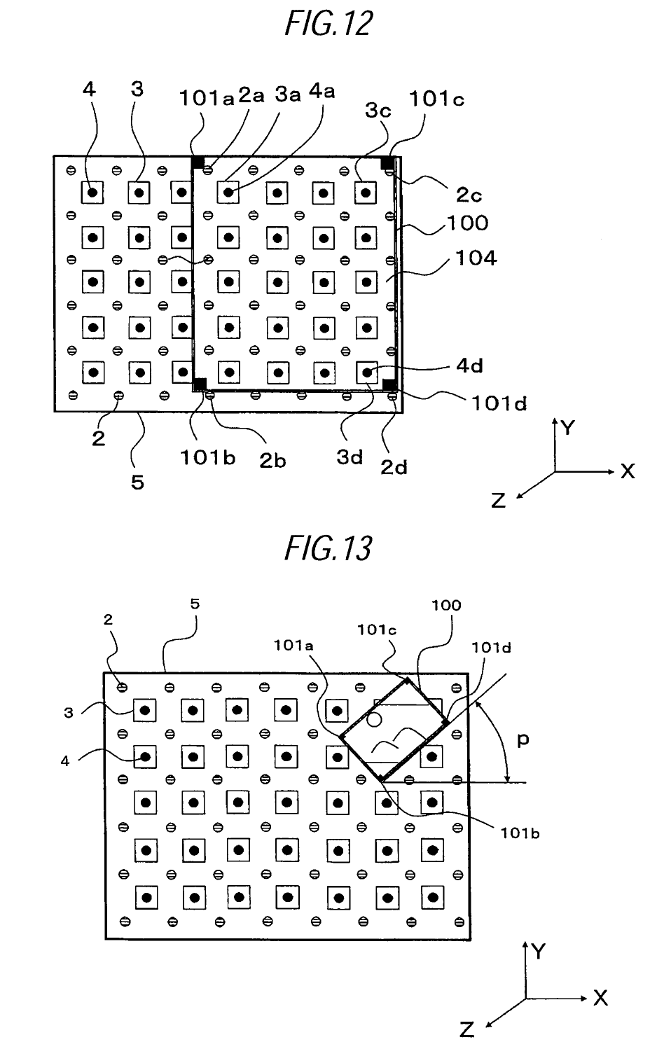

The display position/attitude information detecting step S1 will be described with reference to FIG. 12.

The display position/attitude information detecting step S1 is started by the transmission in which the position markers 101 (101a, 101b, 101c, 101d) disposed in the display 100 transmit the respective signals for enabling their own positions to be detected. The signals are received as a signal related to the position and attitude information by the plural position detecting means 2 which are two-dimensionally placed on the base plate 5. The signals are input into the position/attitude information input portion 71 through the signal line E1. As described above, the intensity of the weak electromagnetic waves transmitted from the position markers 101 can be used as the signals.

The signals are subjected to the calculation process by the calculation process portion 50, to detect the position and attitude information of the display 100. Specifically, the coordinates of the position markers 101 (101a, 101b, 101c) disposed in the display 100 are obtained by the calculation process in the calculation process portion 50, and the position and attitude of the display 100 with respect to the base plate 5 are detected.

In the case where a plurality of displays 100 (100c to 100i) are disposed as in FIG. 9 which has been described above, the positions and attitudes of the all position markers 101 of the disposed displays 100 (100c to 100i) are obtained, and the position and attitude of the displays 100 (100c to 100i) with respect to the base plate 5 are detected.

In this case, also a configuration where the respective display identification information is referred and the displays 100 are correlated with positions and attitudes is effective because of the following reason. In a video signal producing step S6 in the display method which will be described later, there is a case where the configuration effectively functions in determination of the manner of allocating images to the displays.

In the case where the placement of the display 100 is sometimes changed, the display position/attitude information detecting step (S1) may be performed at predetermined time intervals.

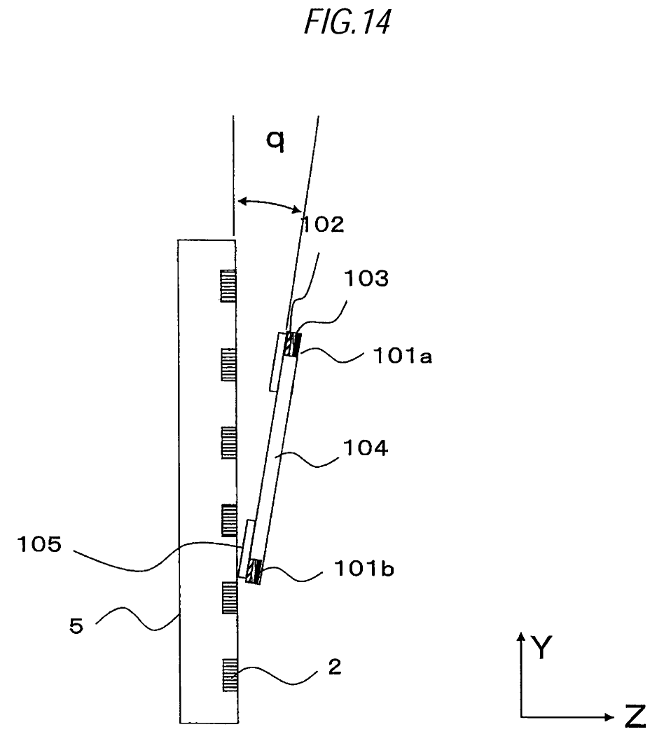

It is a matter of course that, also in the case where the display 100 is inclined by an angle p in the x-y plane as shown in FIG. 13, the case where the display is inclined by an angle q in the y-z plane as shown in FIG. 14, or the case where, although not illustrated, the display is inclined in both the x-y and y-z planes, the position and attitude information can be detected in a manner similar to the above-described manner.

### (Power Supplying Means Selecting Step: S2)

The power supplying means selecting step S2 will be described. The power supplying means selecting step S2 is a step of selecting the power supplying means 3 corresponding to the display 100 on the basis of the position and attitude information of the display detected in the display position/attitude information detecting step S1.

Specifically, the positional relationship of the display 100 with respect to the base plate 5 is identified on the basis of the position and attitude information. The power supplying means 3 which is optimum to the corresponding display 100 is selected on the basis of the position and attitude information of the display 100 with respect to the base plate 5 detected in the display position/attitude information detecting step S1. Specifically, the power supplying means 3 which is closest to the power receiving means 102 disposed in the corresponding display 100 is selected. In the case where the power receiving means 102 and the power supplying means 3 are disposed in a plural number, among candidate combinations of the power receiving means 102 and the power supplying means 3, a combination in which the distance is shortest is selected because the combination is most preferable in view of the power supply loss.

### (Power Supplying/Transmitting Step: S3)

The power supplying/transmitting step S3 will be described. The power supplying/transmitting step S3 has a step (power supplying step S31) of supplying an electric power to the power supplying means 3 selected in the power supplying means selecting step S2, and another step (power transmitting step S32) of transmitting the electric power by wireless from the power supplying means 3 to the power receiving means 102 of the display 100.

Specifically, an electric power is sent from the external power source to the power input portion 72 through the power wiring E4. Next, the electric power is sent to the power supplying means 3 which is selected in the power supplying means selecting step S2, through the power supply portion 31 and the power supply line E2. The electric power is further sent by wireless from the power supplying means 3 to the power receiving means 102 of the display 100.

As described above, part of the electric power which is externally introduced may be previously stored into the power storage portion 32, and, in the case where a power source does not exist in the vicinity of the display, or the like, part or whole of the power stored in the power storage portion 32 may be supplied to the power receiving means 102.

### (Power Receiving/Supplying Step: S4)

The power receiving/supplying step S4 will be described. The power receiving/supplying step S4 has a step (power receiving step S41) of receiving the electric power which is sent from the power supplying means 3 to the power receiving means 102 of the display 100, and another step (received power supplying step S42) of supplying the electric power received by the power receiving means 102 as powers for display and control in the display 100.

The received power supplying step S42 may have a step of charging the display power supply portion (not shown) disposed in the display 100 as described above. In this case, a rechargeable secondary cell such as a nickel-hydride secondary cell may be used as the display power supply portion.

### [Display Method]

The display method for the display in the display system of the invention will be described.

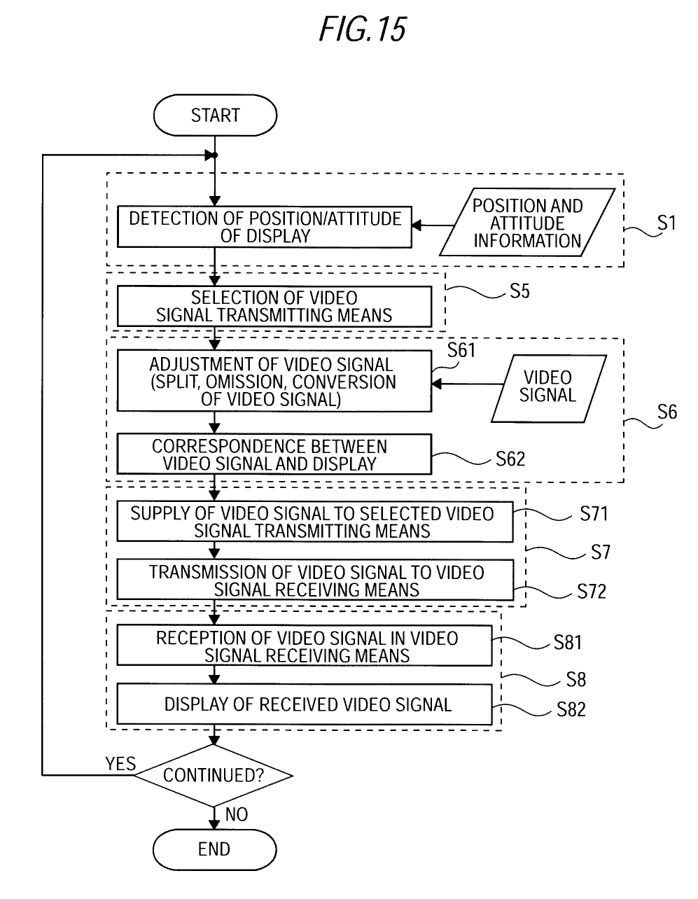

FIG. 15 is a flowchart of a process showing an embodiment of the display method of the invention. The display method may have the display position/attitude information detecting step S1, a video signal transmitting means selecting step S5, the video signal producing step S6, and a video signal supplying/transmitting step S7. The method may have further a video signal receiving/displaying step S8 after the video signal supplying/transmitting step S7.

### (Display Position/Attitude Information Detecting Step: S1)

In the display position/attitude information detecting step S1, the same method as that which has been described in the description of the method of supplying an electric power can be used, and hence its description is omitted.

### (Video Signal Transmitting Means Selecting Step: S5)

The video signal transmitting means selecting step S5 will be described. In the video signal transmitting means selecting step S5, video signal transmitting means corresponding to the display 100 is selected on the basis of the position and attitude information of the display 100 detected in the display position/attitude information detecting step.

Specifically, the positional relationship of the display 100 with respect to the base plate 5 is identified on the basis of the position and attitude information. The video signal transmitting means 4 which is optimum to the corresponding display 100 is selected on the basis of the position and attitude information of the display 100 with respect to the base plate 5 detected in the display position/attitude information detecting step S1. Furthermore, the video signal transmitting means 4 which is closest to the video signal receiving means 103 disposed in the corresponding display 100 is selected. In the case where the video signal receiving means 103 and the video signal transmitting means 4 are disposed in a plural number, among candidate combinations of the video signal receiving means 103 and the video signal transmitting means 4, a combination in which the distance is shortest is selected.

The reason of this is that, in order to suppress the rate of occurrence of communication errors under the environment where a high speed is requested, it is preferable to shorten the communication distance as far as possible.

### (Video Signal Producing Step: S6)

The video signal producing step S6 has an adjustment of a video signal to the display 100 (video signal adjusting step S61), and a correspondence between the video signal and the display (video signal allocating step S62).

The video signal adjusting step S61 for the video signal to the display 100 advances along the following steps. First, a video signal (a video signal corresponding to the original image) is sent from the external video signal source (not shown) to the video signal input portion 73 through the video signal line E5. The video signal is sent to the video signal production portion 41 where the video signal is adjusted to a video signal suitable for displaying a video on the display 100. Specifically, the video signal is adjusted in accordance with the specification and conditions of the display 100 such as the number of the displays 100, the scanning line number, the pixel number, the position (coordinates), and the attitude (inclination).

In the case where a plurality of displays 100 are used, for example, the video signal is adjusted in accordance with the specification and conditions of the displays 100 such as relative positions and attitudes of the displays, gaps between the displays, brightness differences, color tone differences, and contrast differences, or differences in specification and conditions between the displays.

In the case of different scanning line numbers, the scanning lines of a video do not correspond one-to-one to those of a display, and hence their mutual scanning lines are made correspondent with each other. In the case where plural scanning lines of a video correspond to one scanning line of a display, a video signal corresponding to the scanning line can be determined by weighted averaging in accordance with the video intensity and the duty ratio. In the case where plural scanning lines of a display correspond to one scanning line of a video, conversely, a video signal corresponding to the plural scanning lines can be determined by performing weighted averaging for each scanning line. Information related to the specification of a display such as the scanning line number and the pixel number may be previously input into the control portion. Alternatively, information related to the specification may be previously stored in the display 100, and the information may be transmitted to the control portion as required. As a transmission method, a method in which the information is transmitted by wireless between the display 100 and the control portion, or that in which the information is superimposed on the signal transmission between the position marker and the position information detection portion may be employed. In this case, the information received by the position information detection portion is transmitted to the control portion, and then used in the video signal producing step.

In the case where the display 100 is inclined as shown in FIGS. 13 and 14, for example, the attitude (inclination) is corrected so that a video is maintained horizontal. In order to perform the correction, a video signal is corrected so that a video is produced so as to be maintained horizontal with respect to the viewer, on the basis of information related to the attitude information obtained in the above-described display position/attitude information detecting step S1, such as the angles p and q.

In the case where the display system has a plurality of displays 100, a video signal which is adjusted in the video signal production portion 41 is allocated in the video signal allocating step S62 to video signals corresponding respectively to the displays 100. In this case, as described above, the display identification information may be referred, and allocation between the displays and the video signals may be performed. The allocated video signals are sent to the video signal supply portion 42.

For example, the case where, in FIG. 9, the four displays 100d to 100g are placed in a tiled arrangement will be considered. One video is split to the four displays, and video signals which are suitable respectively to the displays are correspondingly allocated to the displays. In the case where one display 100 is used, and the input video signal and the displayed video signal have the same conditions, the video signal allocating step S62 may be omitted. In the above-mentioned step, the video signal may be suitably stored into the video signal storage portion 62.

In the case where at least one of the plural displays 100d to 100g is inclined with respect to the other displays, videos in which the inclination is corrected in accordance with the inclinations of the displays are allocated so that the videos are maintained horizontal with respect to the viewer. In the case where the plural displays 100d to 100g have the same inclination, videos which are made suitable to the displays in accordance with the inclination of the displays are allocated. In this case, the viewer sees the inclined views.

In the case where the plural displays 100d to 100g are placed in a tiled arrangement and the gap between displays which are a part of the plural displays is opened, the center of gravity coordinates of the whole of the plural displays are made coincident with those of a video, the magnification of the video is then adjusted so that the upper, lower, right, and left edges of the video are inside the circumscribed rectangular of the plural displays, and thereafter the video is displayed on the displays while being split.

In the case where the plural displays 100 are placed, the center of gravity coordinates of the whole of the displays mean the geometrical center of gravity of the display portions 104 of the all displays 100. The center of gravity coordinates of the video mean the center of gravity of the pre-allocated video signals, i.e., the original image.

### (Video Signal Supplying/Transmitting Step: S7)

The video signal supplying/transmitting step S7 will be described.

The video signal which is allocated in the video signal allocating step S62 is sent from the video signal supply portion 42 to the video signal transmitting means 4 which is selected in the video signal transmitting means selecting step S5, through the video signal supply line E3 (video signal supplying step S71). Then, the video signal is sent by wireless from the video signal transmitting means 4 to the video signal receiving means 103 of the display 100 (video signal transmitting step S72).

### (Video Signal Receiving/Displaying Step: S8)

The video signal receiving/displaying step S8 has reception of the video signal by the selected video signal receiving means 103 (video signal receiving step S81), and display in which the video signal sent to the video signal receiving means 103 is adequately displayed on the display portion 104 of the display 100 (video signal displaying step S82). At this time, the video signal receiving step S81 and the video signal displaying step S82 are adequately controlled by the display control portion (not shown).

### FIRST EMBODIMENT OF THE INVENTION

Referring to FIG. 12, the embodiment will be described in further detail.

FIG. 12 shows the manner in which the display 100 is placed on the base plate 5 of the back plate 1. The display 100 is a liquid crystal display on which a backlight is mounted, and which has the specification that the diagonal dimension is 19 inches, and the pixel number is 1,440 pixels in the horizontal direction and 900 pixels in the vertical direction.

In the display 100, the position markers 101a to 101d are placed respectively in the four corners. In the position markers 101a to 101d, as shown in FIG. 12, the power receiving means 102a to 102d and the video signal receiving means 103a to 103d are overlappingly disposed in the thickness direction of the display.

First, the coordinates of the position markers 101a to 101d are obtained in the display position/attitude information detecting step S1 to obtain the position and attitude information of the display 100. In the embodiment, a weak electromagnetic wave is transmitted from each of the position markers 101a to 101d. These electromagnetic waves are received by the position detecting means 2 (2a to 2d and the like including plural position detecting means 2) of the display 100, respectively.

It is assumed that, in the embodiment, the position of the position marker 101 is detected from the intensities of the received electromagnetic waves. The intensity of an electromagnetic wave attenuates in inverse proportion to the square of the distance. In the case where, as shown in FIG. 12, the display 100 has a rectangular shape, the position markers 101a to 101d are disposed in the four corners, and the transmission intensities of the electromagnetic waves are previously known, therefore, the position and attitude of the display 100 with respect to the back plate 1 can be obtained from the intensities of the received electromagnetic waves. In this case, the position and the attitude may be obtained by using known geometrical analyzing means.

After the position and attitude of the display 100 are detected as described above, the distance R1 between the power supplying means 3 placed on the base plate 5 and the power receiving means 102 placed in the display 100, and the distance R2 between the video signal transmitting means 4 placed on the base plate 5 and the video signal receiving means 103 placed in the display 100 are obtained. Among the distances R1, R2, the shortest distances are selected, thereby enabling the power supplying means selecting step S2 and the video signal transmitting means selecting step S5 to be performed. In the embodiment, as shown in FIG. 12, the distances between the power supplying means 3d and the video signal transmitting means 4d, and the position marker 101d are shorter than those between the other power supplying means and video signal transmitting means, and the other position markers. Therefore, the power supplying means 3d and the power receiving means (assumed as 102d) corresponding to the power supplying means are selected in the power supplying means selecting step S2. Furthermore, the video signal transmitting means 4d and the video signal receiving means (assumed as 103d) corresponding to the video signal transmitting means are detected in the video signal transmitting means selecting step S5.

In the power supplying/transmitting step S3, an electric power is supplied from the external power source to the selected power supplying means 3d through the power wiring E4, the power input portion 72, the power supply portion 31, and the power supply line E2, and then by wireless to the power receiving means 102d.

By contrast, in the video signal producing step S6, the video signal is adjusted to a video signal suitable for displaying a video on the display 100.

First, the adjustment of the video signal to the display 100 (video signal adjusting step S61) is performed. In this step, the video signal is sent from the external video signal source (not shown) to the video signal production portion 41 through the video signal line E5 and the video signal input portion 73. In the video signal production portion, the video signal is adjusted to a video signal suitable for displaying a video on the display 100.

In the case where the input signal has 1,080 scanning lines and the display 100 has 768 scanning lines, for example, the video signal is adjusted so that one display video signal is produced per 1.4 scanning lines of the input signal. A plurality of video signals are superimposed in the same scanning line, but a signal which is weighted according to the duty ratio can be made correspondent with plural videos.

Next, the correspondence between the video signal and the display (video signal allocating step S62) is performed. In the embodiment, only one display 100 is used. Therefore, it is not necessary to particularly perform a process of splitting the video signal or the like. The video signal which is adjusted in the video signal adjusting step S61 can be made correspondent as it is with the video signal to be displayed on the display 100.

In the video signal supplying/transmitting step S7, the thus adjusted and correspondent video signal is sent from the video signal supply portion 42 to the video signal transmitting means 4d through the video signal supply line E3. Then, the video signal is transmitted by wireless from the video signal transmitting means 4d to the video signal receiving means 103d of the display 100.

The video which is received by the video signal receiving means 103d (video signal receiving step S81) is displayed on the display portion 104 of the display 100 (video signal displaying step S82).

According to the embodiment, in the power supply to the display 100, the power supplying means 3 can be appropriately selected in accordance with the position in the base plate 5, and a display system which is highly efficient and low in power consumption can be realized.

In the supply of a video signal to the display 100, similarly, the appropriate video signal transmitting means 4 can be selected in accordance with the position in the base plate 5, and a video display system which is highly efficient and stabilized can be realized.

### SECOND EMBODIMENT OF THE INVENTION

FIG. 14 shows the case where a part of the display 100 is raised from the base plate 5. In this case, there is a possibility that the position marker 101a of the display 100 is not correctly detected by the position detecting means 2.

In the case where a part of the display 100 is raised in this way, the position marker 101a of the display is remote from the base plate 5, and hence there is a possibility that the position detection is incorrectly performed. Moreover, there are possibilities such as that the efficiencies of wirelessly supplying a video signal and an electric power are lowered, and that the data transfer error is increased.

These problems can be solved by a configuration where a portion of the display 100 which is closest to the base plate 5, or which is contacted with the base plate is detected in the display position/attitude information detecting step S1, the power supplying means 3 and power receiving means 102 which are closest or contacted with each other are selected, and then an electric power is supplied.

Here, the term “contacted” means not only that they are physically contacted with each other, but also that, in the configuration diagram of FIG. 14, for example, a distance between the position marker 101b and one of the position detecting means 2 is within a predetermined range. When the position detecting means 2 detects that the distance is within the predetermined range, it is determined that the display 100 is contacted with the base plate 5, whereby the power supplying means 3 and the power receiving means 102 which are closest or contacted with each other is selected, and the power supply is realized.

This can be performed by a configuration where a plurality of pressure sensors are disposed on the base plate 5, and a display in which the pressure sensing position coincides with the position of the display 100 is determined to be contacted with the base plate 5. According to the configuration, the accuracy and sensitivity of the detection of the position and attitude of the display 100 are improved. Alternatively, a plurality of pressure sensors are disposed in the display 100, and, when one of the pressure sensors senses a pressure which is equal to or higher than a predetermined pressure, the position marker is activated, so that it is determined that the display is contacted with the base plate 5.

The video signal transmitting means 4 and video signal receiving means 103 which are closest or contacted with each other are selected in a similar manner as the selection of the power supplying means 3 and the power receiving means 102, and then a video signal is exchanged.

In order that, in the case where the distance between the position marker 101b and one of the position detecting means 2 is within the predetermined range and the display 100 is detected to be in the raised state, the detection procedure and the predetermined range may be set in the display position/attitude information detecting step S1 so that the viewer is informed of the inadequate placement of the display 100. Specifically, an alarm may be given under such conditions.

In this way, data as to the procedure of detecting the raised state of the display 100 and the predetermined range are previously stored in the information storage portion 60, and the data as to the procedure and the predetermined range are referred in the display position/attitude information detecting step S1, whereby the detection is realized.

According to the configuration of the embodiment, in addition to the video display which is highly efficient, low in power consumption, and stabilized, stabilized wireless supplies of a video signal and an electric power can be realized by detection of a contact between the display and the back plate.

The invention is not restricted to the above-described embodiments, and may be variously embodied without departing from the spirit of the invention.

As described with reference to the embodiment, there is provided a display, back plate, display system, method of supplying an electric power, and display method in which the rate of occurrence of communication errors can be suppressed even under the environment where a high speed is requested.

According to the embodiment, it is possible to provide a back plate, display, display system, method of supplying an electric power, and display method in which the rate of occurrence of communication errors is suppressed even under the environment where a high speed is requested.

What is claimed is:

1. A back plate comprising:
a base plate including a principal surface on which a plurality of power supplying portions, a plurality of image signal transmitting portions, and a position detecting portion are disposed, each of the position detecting portions being configured to detect a position of a display device having a position marker that output information to inform the position of the display device; and
a controller including:
a detector configured to detect position information and attitude information of the display device based on information output from the position detecting portion;
a selector configured to select at least one of power supplying portions and at least one of image signal transmitting portions for operating the display device based on the position information and the attitude information;
a power supply controller configured to supply an electric power to the selected power supplying portion;
an image signal generator configured to produce image signal corresponding to the display device; and
an image signal supply controller configured to supply the produced image signal to the selected image signal transmitting portion.

2. A display device configured to be placed on a back plate to display an image comprising:
a position marker configured to output information to allow the back plate to detect a position of the display device;
a power receiving portion configured to receive an electric power supplied from the back plate;
an image signal receiving portion configured to receive an image signal transmitted from the back plate; and
a display portion configured to display the received image.

3. A display system comprising:
A back plate having:
a base plate including a principal surface on which a plurality of power supplying portions, a plurality of image signal transmitting portions, and a position detecting portion are disposed, each of the position detecting portions being configured to detect a position of a display device having a position marker that output information to inform the position of the display device; and
a controller including:
a detector configured to detect position information and attitude information of the display device based on information output from the position detecting portion;
a selector configured to select at least one of power supplying portions and at least one of image signal transmitting portions for operating the display device based on the position information and the attitude information;
a power supply controller configured to supply an electric power to the selected power supplying portion;
an image signal generator configured to produce image signal corresponding to the display device; and
an image signal supply controller configured to supply the produced image signal to the selected image signal transmitting portion; and
a display device configured to be placed on the back plate to display the produced image including:
a position marker configured to output information to allow the back plate to detect the position of the display device;
a power receiving portion configured to receive the electric power supplied from the back plate;
an image signal receiving portion configured to receive the produced image signal transmitted from the back plate; and
a display portion configured to display the received image.

4. The display system according to claim 3, wherein a non-contact power supply is performed from the power supplying portion to the power receiving portion, and
wherein a non-contact image signal transmission is performed between the image signal transmitting portion and the image signal receiving portion.

5. A power-supply method for supplying an electric power for a display device having a position marker and a power receiving portion, the display device being configured to be disposed on a base plate having a position detecting portion and a plurality of power supplying portions, the method comprising:
detecting position information and attitude information of a display device based on information that the position detecting portion obtains from the position marker;
selecting at least one of the power supplying portions based on the position information and attitude information; and
supplying an electric power to the selected power supplying portion to supply the electric power to the power receiving portion.

6. The method according to claim 5, wherein the selecting step comprises selecting the at least one of the power supplying portion closest to the power receiving portion.

7. An image display method for displaying an image on a display device having a position marker and an image signal receiving portion, the display being configured to be disposed on a base plate having a position detecting portion and a plurality of image signal transmitting portions, the method comprising:
detecting position information and attitude information of a display device based on information that the position detecting portion obtains from the position marker;
selecting at least one of image signal transmitting portions based on the position information and attitude information;
producing an image signal to be displayed on the display device based on the position information and attitude information; and
supplying the produced image signal to the selected image signal transmitting portion to supply the produced image signal to the image signal receiving portion.

8. The method according to claim 7, wherein the selecting step comprises selecting the at least one of image signal transmitting portion closet to the image signal receiving portion.
